(19) United States
(12) Patent Application Publication
(10) Pub. No.: US 2025/0334828 A1
(43) Pub. Date: Oct. 30, 2025

(54) BRIGHT SEMICONDUCTOR VARIABLE OPTICAL ATTENUATOR

(71) Applicant: NeoPhotonics Corporation, San Jose, CA (US)

(72) Inventors: Jian WANG, San Jose, CA (US); Kenneth A. MCGREER, Livermore, CA (US); Calvin HO, San Jose, CA (US); Jerry Liu, San Jose, CA (US); Victor XU, San Jose, CA (US)

(21) Appl. No.: 18/891,788

(22) Filed: Sep. 20, 2024

Related U.S. Application Data
(60) Provisional application No. 63/638,171, filed on Apr. 24, 2024.

(51) Int. Cl. G02F 1/025; H04B 10/40

(52) U.S. Cl. CPC G02F 1/025; H04B 10/40

(57) ABSTRACT

In some implementations, a variable optical attenuator (VOA) circuitry may include a photonic integrated circuit (PIC). The PIC may include a variable optical attenuator (VOA). The VOA may be a positive-intrinsic-negative (PIN)-based VOA. The PIC may further include a shunt resistor and one or more metal layers that connect the shunt resistor in parallel with the VOA. The VOA circuitry may include driving electronics associated with driving the VOA.

### CROSS-REFERENCE TO RELATED APPLICATION

This patent application claims priority to U.S. Provisional Patent Application No. 63/638,171, filed on Apr. 24, 2024, and entitled “SEMICONDUCTOR VARIABLE OPTICAL ATTENUATOR.” The disclosure of the prior application is considered part of and is incorporated by reference into this patent application.

### TECHNICAL FIELD

The present disclosure relates generally to a variable optical attenuator (VOA), and to a bright semiconductor VOA.

### BACKGROUND

An optical attenuator is a device used for reducing optical power of an optical signal. A variable optical attenuator (VOA) is an optical attenuator with a degree of attenuation that can be adjusted manually or controlled with an electrical signal. VOAs play an important role in dense wavelength-division multiplexing (DWDM) optical communication networks, specifically in applications such as coherent transceivers, integrated variable optical attenuator multiplexers (VMUXs), or reconfigurable optical add-drop multiplexers (ROADMs). As another example, VOAs can be used in intensity-modulation direct-detection (IM-DD) transceivers (e.g., deployed within data centers).

### SUMMARY

In some implementations, a variable optical attenuator (VOA) circuitry comprises: a photonic integrated circuit (PIC) comprising: a VOA, wherein the VOA is a positive-intrinsic-negative (PIN)-based VOA, a shunt resistor, and one or more metal layers that connect the shunt resistor in parallel with the VOA; and driving electronics associated with driving the VOA.

In some implementations, a coherent optical transceiver includes a PIC comprising: a transmitter (TX) including a TX VOA and a TX shunt resistor, the TX shunt resistor being connected in parallel with the TX VOA, wherein the TX VOA is a PIN-based VOA, and a receiver (RX) including an RX VOA and an RX shunt resistor, the RX shunt resistor being connected in parallel with the RX VOA, wherein the RX VOA is a PIN-based VOA; and driving electronics associated with driving the TX VOA and the RX VOA.

In some implementations, an optical device includes a PIC including: a PIN-based VOA, and an on-PIC shunt resistor associated with bypassing a leakage current of driving electronics associated with driving the PIN-based VOA, wherein the on-PIC shunt resistor is connected in parallel with the PIN-based VOA; and the driving electronics associated with driving the PIN-based VOA.

### BRIEF DESCRIPTION OF THE DRAWINGS

FIGS. 1A-1B are diagrams associated with a conventional PIN-based VOA.

FIGS. 2A-2E are diagrams illustrating examples associated with a VOA circuitry comprising a PIC including a PIN-based VOA and a shunt resistor as described herein.

FIGS. 3A-3D are diagrams illustrating examples illustrating a current-voltage curve and alternating current (AC) on-resistances associated with a PIN-based VOA that does not include a shunt resistor.

FIG. 4A is a diagram illustrating examples of distribution of source current between a PIN-based VOA and a shunt resistor as described herein.

FIG. 4B is a diagram illustrating examples of a comparison of current across a PIN-based VOA with a shunt resistor described herein and a conventional PIN-based VOA that does not include a shunt resistor.

FIG. 5 illustrates an example of a linear relationship between an output voltage of a digital-to-analog convertor (DAC) and a source current from driving electronics as described herein.

FIGS. 6A-6B are diagrams associated with an additional example of VOA circuitry comprising a PIC including a PIN-based VOA and a shunt resistor as described herein.

### DETAILED DESCRIPTION

The following detailed description of example implementations refers to the accompanying drawings. The same reference numbers in different drawings may identify the same or similar elements.

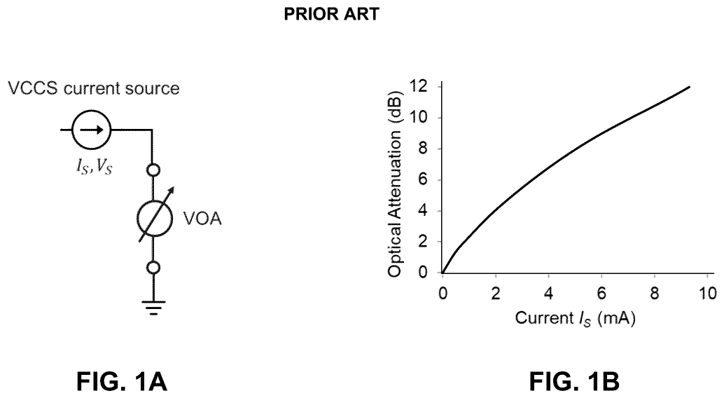

A positive-intrinsic-negative (PIN) junction diode based VOA (herein referred to as a PIN-based VOA) is designed to attenuate an optical signal through free carrier absorption. FIGS. 1A-1B are diagrams associated with a conventional PIN-based VOA. As illustrated in the electrical schematic shown in FIG. 1A, the conventional PIN-based VOA is sourced by a voltage-controlled-current-source (VCCS). In general, as illustrated in FIG. 1B, optical attenuation applied by a conventional silicon photonics PIN-based VOA increases monotonically with source current from the VCCS. The monotonic increase in attenuation simplifies calibration of a PIN-based VOA (e.g., as compared to calibration of a Mach-Zehnder-interferometer (MZI)-based thermal VOA, which does not exhibit a monotonic increase in attenuation with current). Further advantages of the PIN-based VOA (e.g., as compared to an MZI-based thermal VOA) include a small footprint, a wide attenuation range (e.g., greater than approximately 30 decibels (dB)), and a fast response time (e.g., on the order of nanoseconds). Notably, these features are favored for an integrated PIC design and an optical transceiver design.

When being used in an optical link, a VOA can be set to be optically transparent to enable maximum optical link power. A bright VOA is preferable in such an application (e.g., zero dB attenuation is applied at zero bias voltage or zero current). In principle, a conventional PIN-based VOA operates as a “bright” VOA. That is, 0 dB attenuation is applied by the conventional PIN-based VOA through setting a zero ampere (A) VCCS source current, which is achieved through setting a zero volt (V) control voltage to the VCCS. The control voltage to the VCCS is commonly an output voltage of a DAC of a control chip (e.g., an application-specific integrated circuit (ASIC) chip, such as a microcontroller unit (MCU) chip). However, in practice, a voltage offset at the output of the DAC is inevitable. This non-ideal voltage offset results in a current offset at the output of the VCCS, meaning that there is some amount of leakage current from the VCCS. This leakage current sourced to the PIN-based VOA causes undesirable attenuation. Thus, the conventional PIN-based VOA does not operate as a truly bright VOA due to this leakage current. For instance, with respect to the example shown in FIG. 1B, a typical leakage current of 0.25 milliamps (mA) from the VCCS leads to an undesirable attenuation of approximately 0.5 dB by the conventional PIN-based VOA.

It follows that the undesirable attenuation applied by the conventional PIN-based VOA as a result of the leakage current causes the VOA to deviate from an expected or desired performance (i.e., the leakage current degrades performance of the conventional PIN-based VOA). The undesirable attenuation imposes a challenge to optical device design by substantially compromising a link power budget. Further, the attenuation is also wavelength and temperature dependent due to inherent characteristics of PIN-based VOAs, which can result in power calibration issues. The leakage current issue is particularly problematic for conventional PIN-based VOAs with higher maximum attenuation requirements (e.g., on the order of approximately 20 dB to approximately 30 dB). This is because the leakage current of the VCCS is proportional to the maximum VCCS current required to achieve the maximum VOA attenuation, as described in further detail below.

Some implementations described herein provide a VOA circuitry that enables a truly bright VOA. In some implementations, the VOA circuitry described herein comprises a PIC comprising a PIN-based VOA, a shunt resistor (e.g., an on-PIC shunt resistor), and one or more metal layers that connect the shunt resistor in parallel with the PIN-based VOA. The VOA circuitry further includes driving electronics (e.g., a VCCS) associated with driving the VOA. In some implementations, the VOA circuitry described herein mitigates the leakage current issue that is encountered by a conventional PIN-based VOA. As described below, mitigation of the leakage current is provided through bypassing the leakage current by the shunt resistor. As a result, the VOA circuitry described herein enables a PIN-based VOA that is not impacted by leakage current and, therefore, allows the PIN-based VOA to match an expected or desired performance of a bright VOA. Notably, the use of an on-PIC shunt resistor does not affect the attenuation performance of the PIN-based VOA at high currents. Further, adding on-PIC shunt resistor(s) does not increase a size of the PIC. Additional details are provided below.

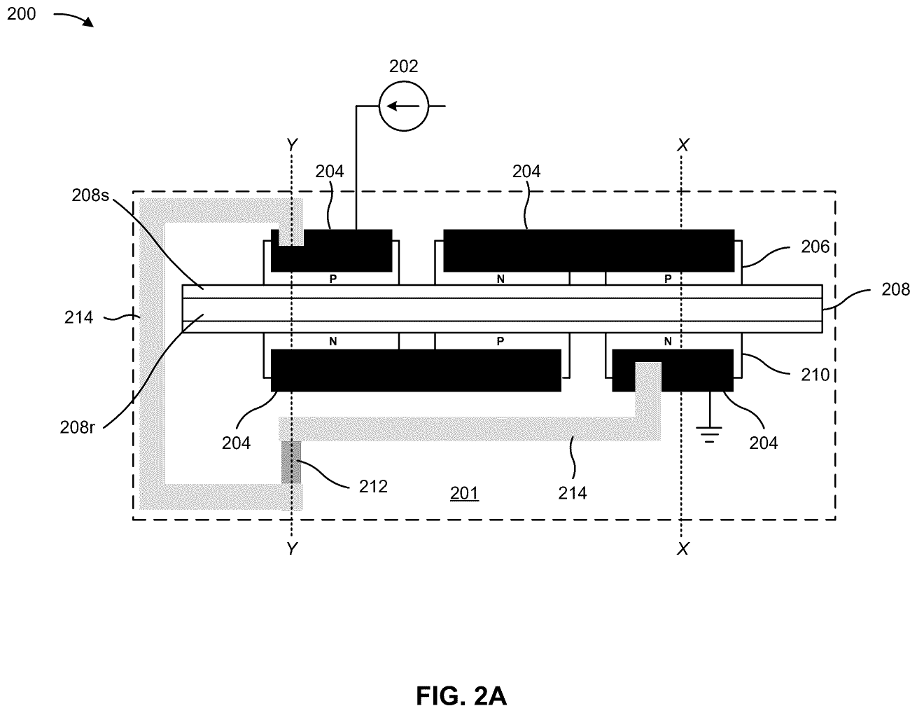

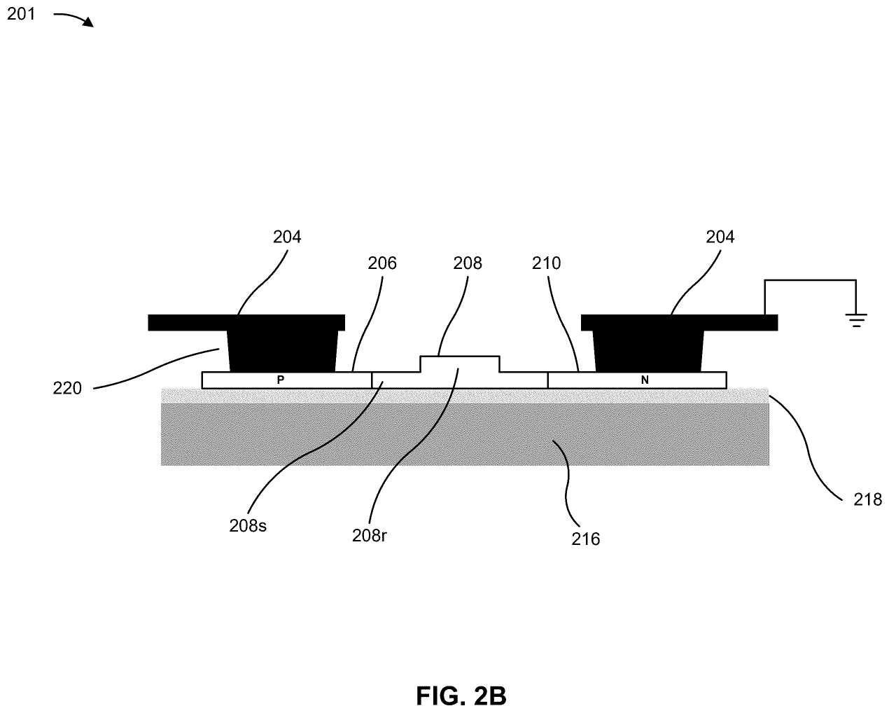

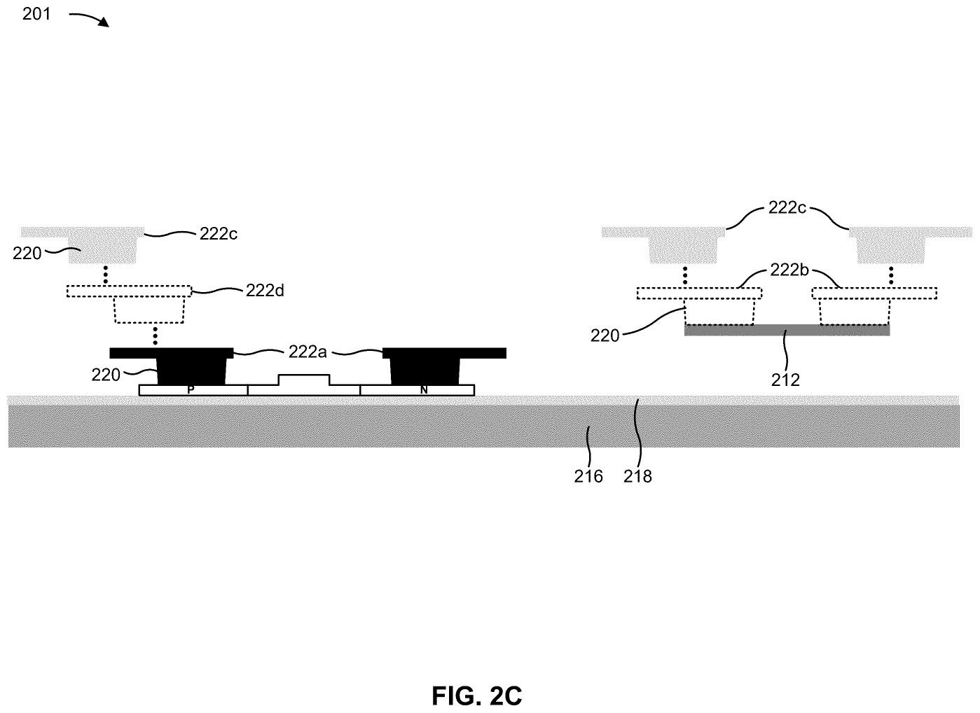

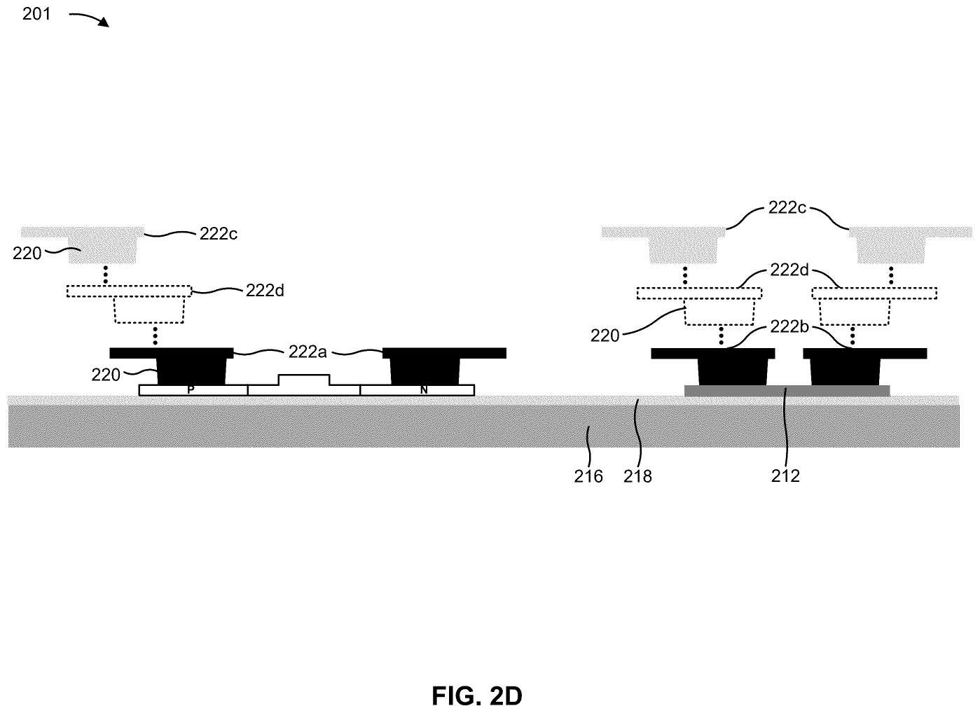

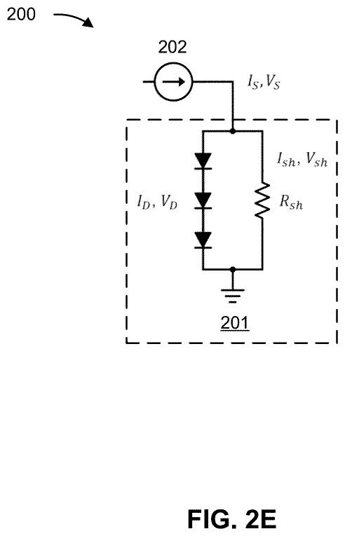

FIGS. 2A-2E are diagrams associated with an example VOA circuitry 200 comprising a PIN-based VOA and a shunt resistor as described herein. As shown, the VOA circuitry 200 includes a PIC 201 (e.g., a silicon photonics PIC) and driving electronics 202. FIG. 2A is a top view of the VOA circuitry 200. FIG. 2B is an example of a cross-section of the PIC 201 of the VOA circuitry 200 at line X-X in FIG. 2A. FIGS. 2C and 2D are examples of a cross-section of the PIC 201 of the VOA circuitry 200 at the line “Y-Y” in FIG. 2A. FIG. 2E is a diagram illustrating an electrical schematic of the VOA circuitry 200.

As shown in FIG. 2A, the VOA circuitry 200 may include a PIC 201 and driving electronics 202. In some implementations, the driving electronics 202 may include a VCCS. In some implementations, the driving electronics 202 may interface with a DAC inside a control chip (e.g., an ASIC chip, such as an MCU chip) in an optical device, such as a transceiver, a VMUX, or a ROADM, among other examples.

In some implementations, the PIC 201 may include a set of electrodes 204 (e.g., metal electrodes), a set of P-type regions 206 (e.g., P-type doped silicon), a rib waveguide 208 (e.g., a rib waveguide in an intrinsic silicon region) comprising a slab 208s and a rib 208r, a set of N-type regions 210 (e.g., N-type doped silicon), a shunt resistor 212, and a set of routing elements 214. As shown in the cross-sections of FIGS. 2B-2D, the PIC 201 may include a substrate 216 (e.g., a silicon substrate) and an insulator layer 218 (e.g., a buried oxide (BOX) layer) over which other elements of the PIC 201 are formed.

In some implementations, elements of the PIC 201 form a PIN-based VOA. In some implementations, the PIN-based VOA is formed in rib waveguide 208, with the P-type regions 206 and the N-type regions 210 of the PIC 201 serving as contact regions. The P-type regions 206 and the N-type regions 210 of the PIC 201 are positioned sufficiently far from the rib 208r to avoid introducing any loss to the optical signal at a zero source current. In some implementations, the electrodes 204 are connected to the P-type regions 206 and the N-type regions 210 through vias 220 and (optionally) one or more metal layers 222, as described below with respect to FIGS. 2B-2D. In the PIC 201 associated with FIGS. 2A-2E, three PIN junctions are connected in series to form the PIN-based VOA. Further, the shunt resistor 212 is connected to the PIN-based VOA through one or more routing elements 214 (e.g., on-PIC metal routing). In operation of the VOA circuitry 200, an optical signal propagates through the rib waveguide 208, and the PIN-based VOA attenuates the optical signal when current is sourced to the PIN junctions by the driving electronics 202. Attenuation can be controlled by varying the source current to the PIN junctions.

The VOA circuitry 200 is configured such that the leakage current does not impact the operation of the PIN-based VOA. More specifically, the shunt resistor 212 of the PIC 201 bypasses leakage current of the driving electronics 202 so that the leakage current does not cause undesired attenuation by the PIN-based VOA. In some implementations, to enable bypassing of the leakage current, the shunt resistor 212 is connected in parallel to the PIN-based VOA of the VOA circuitry 200. Additional details regarding the bypassing of the leakage current by the shunt resistor 212 are provided below.

As noted above, the shunt resistor 212 is connected in parallel to the PIN-based VOA of the PIC 201. In some implementations, a first terminal of the shunt resistor 212 is connected to an anode of the PIN-based VOA through one or more routing elements 214 (e.g., on-chip metal routing) and a second terminal of the shunt resistor 212 is connected to a cathode of the PIN-based VOA through one or more routing elements 214. FIG. 2B is a diagram illustrating an example cross-section of the PIC 201 at line X-X of FIG. 2A. The cross-section shown in FIG. 2B is a cross section of one PIN junction of the PIN-based VOA formed in the PIC 201 of the VOA circuitry 200. In the example shown in FIG. 2B, the electrodes 204 are connected to a P-type region 206 and an N-type region 210 through vias 220. In some implementations, the electrodes 204 are formed from one or more metal layers 222, as described below with respect to FIGS. 2C-2D.

FIGS. 2C and 2D are diagrams illustrating example cross-sections at line Y-Y of FIG. 2A. The cross-sections shown in FIGS. 2C and 2D are cross-sections at one PIN junction and the shunt resistor 212 of the PIC 201. In some implementations, the shunt resistor 212 may comprise a metal (e.g., tungsten (W)) or a metal alloy (e.g., titanium nitride (TiN)). FIG. 2C illustrates an example PIC 201 in which the shunt resistor 212 is implemented using a metal or a metal alloy. In some implementations, as shown in FIG. 2C, the shunt resistor 212 is at a different layer of the PIC 201 than the rib waveguide 208. In some implementations, the shunt resistor 212 may comprise doped silicon (e.g., P-type doped silicon or N-type doped silicon). FIG. 2D illustrates an example PIC 201 in which the shunt resistor 212 is implemented using doped silicon. In some implementations, as shown in FIG. 2D, the (doped silicon) shunt resistor 212 is at the same layer of the PIC 201 as the rib waveguide 208 of the PIN junction.

In some implementations, as illustrated in FIGS. 2C and 2D, the PIC 201 may include sets of metal layers 222, such as a first set of metal layers 222a, a second set of metal layers 222b, a third set of metal layers 222c, and a fourth set of metal layers 222d. In some implementations, the use of multiple metal layers 222 simplifies electrical routing on the PIC 201 by, for example, eliminating a need for routing traces for the shunt resistor 212 and routing traces for the PIN junctions to cross one another. In some implementations, the first set of metal layers 222a comprises one or more metal layers connected to the PIN-based VOA of the PIC 201 (e.g., through one or more vias 220). In some implementations, portions of the first set of metal layers 222a may serve as electrodes 204 of the PIC 201 (so that source current can be provided to the PIN-based VOA). In some implementations, the second set of metal layers 222b comprises one or more metal layers connected to the shunt resistor 212 through one or more vias 220 (so that source current can be provided to the shunt resistor 212). In some implementations, the third set of metal layers 222c comprises one or more metal layers that connect the shunt resistor 212 in parallel with the PIN-based VOA (e.g., through one or more vias 220) and provide routing. In some implementations, the fourth set of metal layers 222d comprises one or more metal layers that serve to further enable routing and/or the connection of the shunt resistor 212 in parallel with the PIN-based VOA. In some implementations, portions of any of the first set of metal layers 222a, the second set of metal layers 222b, the third set of metal layers 222c, and/or the fourth set of metal layers 222d may serve as routing elements 214 of the PIC 201.

Notably, in some implementations, the second set of metal layers 222b and/or the fourth set of metal layers 222d may be absent from the PIC 201. For example, with respect to the example shown in FIG. 2C, the second set of metal layers 222b and/or the fourth set of metal layers 222d may in some implementations not be included in the PIC 201. In such an implementation, the third set of metal layers 222c may serve as the contact to the shunt resistor 212 (e.g., through one or more vias 220) and may be used to provide a connection to the first set of metal layers 222a (e.g., through one or more vias). As another example, with respect to the example shown in FIG. 2D, the fourth set of metal layers 222d may in some implementations not be included in the PIC 201. In such an implementation, the third set of metal layers 222c may be used to provide connection to the first set of metal layers 222a (e.g., through one or more vias 220) and to the second set of metal layers 222b (e.g., through one or more vias 220).

As indicated above, FIGS. 2A-2E are provided as examples. Other examples may differ from what is described regarding FIGS. 2A-2E. The number and arrangement of elements shown in FIGS. 2A-2E are provided as an example. In practice, there may be additional elements, fewer elements, different elements, or differently arranged elements than those shown in FIGS. 2A-2E. Furthermore, two or more elements shown in FIGS. 2A-2E may be implemented within a single element, or a single element shown in FIGS. 2A-2E may be implemented as multiple, distributed elements. Additionally, or alternatively, a set of elements (e.g., one or more elements) shown in FIGS. 2A-2E may perform one or more functions described as being performed by another set of elements shown in FIGS. 2A-2E.

In some applications, the VOA circuitry 200 may need to apply attenuation in a range from approximately 10 dB to approximately 30 dB. One example of such an application is the use of the VOA circuitry 200 in a coherent transceiver. In a coherent transceiver, both a TX and an RX incorporate VOA functionality. During the bring-up stage of the coherent transceiver, a set of VOAs in the TX shut transmission off in order to prevent any output (e.g., to a DWDM network). Attenuation required to shut transmission off may be in a range from approximately 20 dB to approximately 30 dB. During normal operation of the coherent transceiver, the set of VOAs of the TX can attenuate output power within a few dB (e.g., to comply with a power specification of the DWDM network). At the RX side, if power of an incoming optical signal is above a threshold, a set of VOAs in the RX attenuate the incoming optical signal and prevent saturation of trans-impedance amplifiers (TIA) of the RX. Attenuation required on the RX side may be in a range from approximately 10 dB to approximately 15 dB.

In an application in which attenuation in a range from approximately 10 dB to approximately 30 dB is needed (e.g., in a coherent transceiver as described above), a PIN-based VOA comprising one single PIN junction requires more than 100 mA of current from the driving electronics 202 to achieve the desired attenuation. Such a high source current is undesirable from a hardware design perspective, for a number of reasons. One reason is that the high source current limits the choice of IC chips. Another reason is that a high source current requires careful design of all interconnects in the current path (e.g., wide interconnect traces reduce resistance but consume valuable printed circuit board (PCB) space, which may be limited). When multiple PIN junctions are connected in series (both electrically and optically) to form a PIN-based VOA, the required attenuation from each individual PIN junction is a fraction of the total attenuation required. Consequently, the source current requirement is reduced by approximately the same fraction. Thus, in some implementations, the PIN-based VOA of the PIC 201 includes a plurality of PIN junctions. For example, as noted above and as illustrated in the examples of FIGS. 2A-2E, the PIN-based VOA may be formed to include three PIN junctions connected in series (both electrically and optically). Here, the three PIN junctions being connected in series reduces a source current requirement by approximately a factor of three. In some implementations, as shown in FIG. 2A, the PIN junctions of the PIN-based VOA of the PIC 201 are arranged in an alternating configuration to avoid a need for routing elements 214 (e.g., metal traces) connecting the PIN junctions to cross one another.

Notably, additional PIN junctions (e.g., more than three) connected in series may be used to further reduce the VCCS current requirement. However, the use of multiple PIN junctions requires an increase of source voltage from the driving electronics 202 and consequently an increase of supply voltage to the driving electronics 202, compared to that required for a single PIN junction. For example, if the turn-on voltage of a single PIN junction of the PIC 201 is 0.7 V, the PIN-based VOA comprising three PIN junctions connected in series has a turn-on voltage equal to approximately 2.1 V (e.g., 3×0.7 V=2.1 V). In this example, the source voltage from the VCCS driving electronics 202 that is required to achieve 10 dB to 30 dB attenuation would be higher than VOA's turn-on voltage of 2.1 V, reaching 3.0 V. Further, in this example, the supply voltage to the driving electronics 202 must be even higher than the source voltage from the driving electronics 202. A typical supply voltage to a pluggable optical transceiver is approximately 3.3 V, which is sufficient to drive a VOA circuitry 200 comprising a PIN-based VOA composed of three PIN junctions in series. However, if more than three PIN junctions are connected in series, a supply voltage higher than 3.3V would be needed by the VCCS driving electronics 202 and a DC-to-DC (direct current) convertor would need to be added to the transceiver to supply such a high voltage. Such an implementation may be undesirable due to, for example, the increased PCB space and the reduced power efficiency of the optical transceiver.

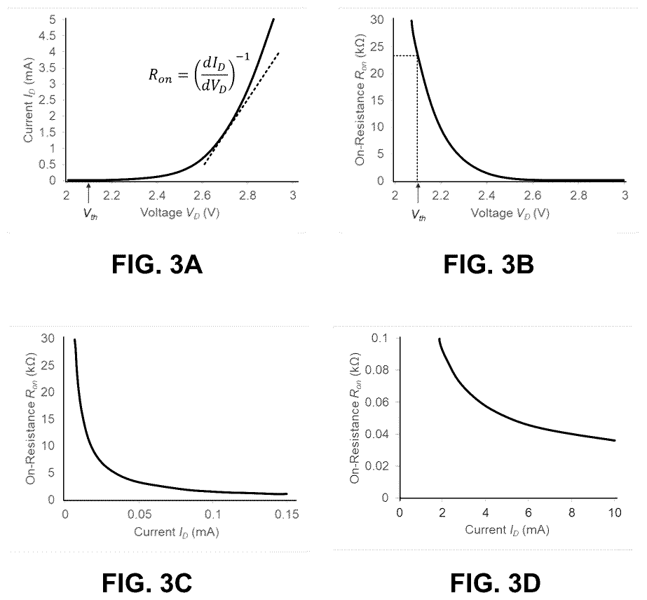

The shunt resistor 212 is designed to bypass small leakage current from driving electronics 202 without compromising VOA's normal operation at high source currents. The key lies in the wide varication of VOA's resistance (without a shunt resistor) with respect to current or voltage. FIG. 3A illustrates an example of a current-voltage (I-V) curve of the PIN-based VOA in FIG. 2E, but without the shunt resistor. As shown in FIG. 3A, the current I_{D} of the PIN-based VOA increases exponentially with the voltage across the VOA V_{D}. The turn-on threshold voltage Vₜₕ of a PIN-based VOA, comprising three PIN junctions connected in series, is approximately 2.1 V. Once the voltage exceeds the threshold Vₜₕ, the PIN-based VOA begins to conduct current and exhibits a resistive behavior. An alternating-current (AC) on-resistance (Rₒₙ), which is defined as the derivative of the I-V curve, is typically used to characterize the resistive behavior of the PIN junctions after they have been turned on.

$${R}_{o n} = \frac{{dV}_{D}}{{dI}_{D}} \qquad ( 1 )$$

For example, in FIG. 3A, at a current I_{D} of 2 mA (corresponding to a voltage V_{D} of approximately 2.75 V), Rₒₙ is calculated to be approximately 92Ω. This is illustrated more clearly in FIG. 3D, where the calculation of AC on-resistance Rₒₙ is extended to a large current range. In FIG. 3D, Rₒₙ is approximately 92Ω at a current I_{D} of 2 mA, and it decreases exponentially as the current I_{D} increases. In FIG. 3B, Rₒₙ is plotted as a function of the voltage V_{D} and decreases exponentially with increasing voltage V_{D}. The calculation of AC on-resistance Rₒₙ in FIG. 3B is extended further to a voltage range below the threshold Vₜₕ, where the PIN-based VOA exhibits mainly diode behavior rather than resistive behavior.

Although AC on-resistance is not well-defined in the voltage range below the threshold Vₜₕ, the exponential decay trend of AC on-resistance across the entire voltage range effectively illustrates how the current-conducting capability of the PIN-based VOA varies with voltage (FIG. 3B) or current (FIG. 3C). For example, at the turn-on threshold voltage of 2.1 V (e.g., Vₜₕ=2.1 V), the calculated AC on-resistance is approximately 23 kiloohms (kΩ). At 2.1 V, the current Ip passing through the VOA is approximately 0.01 mA, and the direct-current (DC) resistance, defined as the ratio of voltage to current, is approximately 210 kΩ(i.e., 2.1 V/0.01 mA=210 kΩ). While the AC on-resistance value deviates from the DC resistance value, it still reflects the weak current-conducting capability of PIN junctions below the turn-on threshold voltage Vₜₕ.

FIG. 3C shows the same plot as FIG. 3D but over a narrower current range (down to 0.15 mA) and a larger resistance range (up to 30 kΩ). The exponential decay characteristics of the VOA's current-conducting capability allows for the use of a shunt resistor to bypass small leakage current without compromising VOA's normal operation at high source currents. The resistance value of the shunt resistor 212 needs to be chosen between the DC resistance value of the VOA at the turn-on threshold voltage and the AC on-resistance value of the VOA at high source currents. Below the threshold voltage Vₜₕ, the shunt resistor bypasses all of the source current (including the leakage current). At high source currents, the current passing through the shunt resistor saturates and it would not affect VOA's attenuation during normal operation. More details are described below. As indicated above, FIGS. 3A-3D are provided as examples. Other examples may differ from what is described with regard to FIGS. 3A-3D.

FIG. 2E shows the electrical schematic of the VOA circuitry 200, which includes a PIC 201 comprising of a PIN-based VOA and a shunt resistor 212. With reference to FIG. 2E, I_{S} and V_{S} represent the source current and source voltage, respectively, of the driving electronics 202. The voltage drop across the shunt resistor 212 (Rₛₕ) is represented as Vₛₕ and the current through the shunt resistor 212 is represented as Iₛₕ. Due to the parallel connection of the PIN-based VOA and the shunt resistor 212, the source current I_{S} and voltage V_{S} from the driving electronics 202 satisfy the following relationships:

$${I}_{S} = {I}_{D} + {I}_{s h} \qquad ( 2 )$$

$${V}_{S} = {V}_{D} = {V}_{s h} \qquad ( 3 )$$

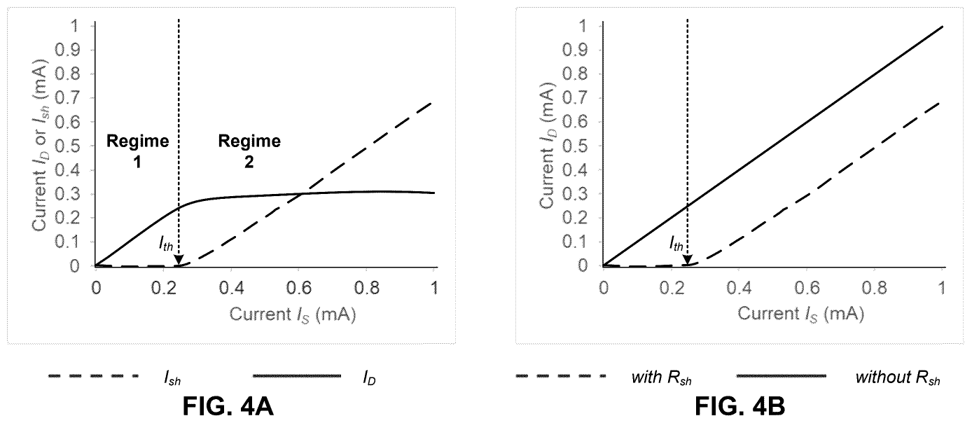

The operation of the PIN-based VOA with the shunt resistor 212 could be described in two regimes. With reference to FIG. 4A, a boundary between these two regimes is approximately at a threshold source current Iₜₕ. In Regime 1, the source current I_{S} (including any leakage current) from the driving electronics 202 is small, and a voltage drop across the shunt resistor 212 (Vₛₕ) does not reach the turn-on threshold voltage of the PIN-based VOA. As a result, no current passes through the PIN-based VOA, and the shunt resistor 212 bypasses all the source current I_{S}. FIG. 4A illustrates the distribution of source current I_{S} between the PIN-based VOA and the shunt resistor 212 of the PIC 201. As shown, in Regime 1, the current Iₛₕ through the shunt resistor 212 increases linearly with I_{S} until it reaches Iₜₕ, whereas the current I_{D} through the PIN-based VOA remains at zero. Therefore, as long as a leakage current Iₗₑₐₖ is below the threshold current Iₜₕ, the shunt resistor 212 bypasses all of the leakage current Iₗₑₐₖ.

$${I}_{l e a k} \leq {I}_{th} \qquad ( 4 )$$

Consequently, the undesirable attenuation caused by the leakage current Iₗₑₐₖ is mitigated by the shunt resistor 212 of the PIC 201.

In Regime 2 of FIG. 4A, when the source current I_{S} increases and becomes large enough, the voltage drop Vₛₕ across the shunt resistor 212 reaches the turn-on threshold voltage of the PIN-based VOA Vₜₕ (i.e., Vₛₕ=Vₜₕ). At this point, the source current I_{S} from the driving electronics 202 that is needed to reach the turn-on threshold voltage of the VOA is defined as the threshold current Iₜₕ. Iₜₕ can therefore be calculated using:

$${I}_{th} = {I}_{D} + {I}_{s h} ≅ {I}_{s h} = {V}_{s h} / {R}_{s h} = {V}_{th} / {R}_{s h} \qquad ( 5 )$$

As shown in FIG. 4A, when the source current I_{S} is higher than the threshold current Iₜₕ, the current in the PIN-based VOA (Ip) begins to increase with I_{S} at a rate of approximately one. Meanwhile, the current in the shunt resistor 212 (Iₛₕ) increases from the value of Iₜₕ slightly and saturates quickly. Therefore, once the PIN-based VOA of the PIC 201 is turned on, the shunt resistor 212 would therefore not affect normal operation of the PIN-based VOA, since it would not bypass more current than Iₜₕ. In other words, during VOA's normal operation in Regime 2, the AC on-resistance of PIN-based VOA is much smaller than the resistance of the shunt resistor 212:

$${R}_{o n} << {R}_{s h} \qquad ( 6 )$$

As shown in FIG. 3D, the AC on-resistance of the PIN-based VOA is approximately 92Ω at 2 mA source current and it drops further at higher currents (e.g. tens of mA). The resistance value of the shunt resistor 212 may be significantly higher than this, as described in further details below. The characteristics of VOA's resistance curve ensures that the current on the shunt resistor 212 (Iₛₕ) saturates quickly once the PIN-based VOA of the PIC 201 is turned on (e.g., so as to ensure that the shunt resistor 212 does not impact operation of the PIN-based VOA).

FIG. 4B illustrates a comparison of the current through the PIN-based VOA of the PIC 201 and a conventional PIN-based VOA that does not include the shunt resistor 212. As shown, the current I_{D} in PIN-based VOA of the PIC 201 (represented by the dashed line labeled “with Rₛₕ”) and the current I_{D} in the conventional PIN-based VOA (represented by the solid line labeled “without Rₛₕ”) are nearly parallel across the source current range above the threshold current Iₜₕ, with the current I_{D} in the PIN-based VOA of the PIC 201 being shifted by an amount approximately equal to Iₜₕ. Such a relationship illustrates that the shunt resistor 212 bypasses all of the source current (including the leakage current) below Iₜₕ without compromising normal operation of the PIN-based VOA of the PIC 201 at high currents. As indicated above, FIGS. 4A-4B are provided as examples. Other examples may differ from what is described with regard to FIGS. 4A-4B.

In some implementations, based on a typical range of leakage current Iₗₑₐₖ and a threshold voltage Vₜₕ of the PIN-based VOA of the PIC 201, an upper limit of the resistance of the shunt resistor 212 (Rₛₕ) can be estimated using:

$${R}_{s h} = \frac{{V}_{t h}}{{I}_{t h}} \leq \frac{{V}_{t h}}{{I}_{l e a k}} \qquad ( 7 )$$

More particularly, in some implementations, the resistance value Rₛₕ is less than or equal to the turn-on threshold voltage Vₜₕ divided by the leakage current Iₗₑₐₖ of the driving electronics 202. Taking the VOA circuitry 200 of FIGS. 2A-2E as an example, the turn-on threshold voltage Vₜₕ of the PIN-based VOA of the PIC 201 may be 2.1 V (e.g., the threshold voltage Vₜₕ typically varies within a small range across different chips and wafers). Further, a typical leakage current Iₗₑₐₖ may be up to approximately 0.25 mA. Thus, in this example, the upper limit of the resistance Rₛₕ of the shunt resistor 212 should be less than approximately 8.4 kΩ (e.g., Rₛₕ≤2.1 V/0.25 mA=8.4 kΩ). This Rₛₕ value is much lower than VOA's DC resistance value of approximately 120 kΩ≤2 at Vₜₕ=2.1 V. And it is well above the VOA's AC on-resistance value of tens of Ohms at a high current (i.e. I_{D}>2 mA). At a source voltage below the threshold voltage Vₜₕ, the shunt resistor bypasses all the source current, whereas at a high source current, the current through shunt resistor saturates around Iₜₕ. Thus, the shunt resistor 212 can bypass small leakage current from driving electronics 202 while not compromising VOA's normal operation at high source currents.

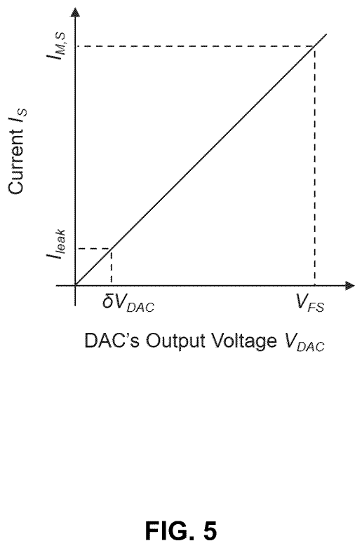

In some implementations, the leakage current Iₗₑₐₖ can be estimated in association with the characteristics of a DAC in a control chip. As noted above, the leakage current Iₗₑₐₖ may be caused by an output voltage offset of a DAC (δV_{DAC}) and an output current offset of an operational amplifier of the driving electronics 202 (δI_{Op}). Here, the leakage current Iₗₑₐₖ can be estimated using:

$${I}_{l e a k} = G \times δ {V}_{DAC} + δ {I}_{O p} \approx G \times δ {V}_{DAC} \qquad ( 8 )$$

where G represents a trans-conductance gain of the VCCS driving electronics 202. In practice, the leakage current is dominated by the first term in (8), meaning that Iₗₑₐₖ can be estimated as being approximately equal to the trans-conductance gain G times the output voltage offset of the DAC δV_{DAC} (e.g., Iₗₑₐₖ≈G×δV_{DAC}). FIG. 5 illustrates an example of a linear relationship between an output voltage of a DAC (V_{DAC}) and the source current I_{S} from the driving electronics 202. Here, a slope of the curve represents the trans-conductance gain G of the driving electronics 202. As shown in FIG. 5, at a full-scale output of the DAC (V_{FS}), the source current I_{S} reaches the maximum current I_{M,S}. At this current, the PIN-based VOA achieves its maximum attenuation. The leakage current Iₗₑₐₖ can therefore be estimated using:

$$\frac{{I}_{l e a k}}{δ {V}_{DAC}} = G = \frac{{I}_{M , S}}{{V}_{FS}} \qquad ( 9 )$$

Thus, the leakage current Iₗₑₐₖ of the driving electronics 202 may in some cases be determined by one or more output characteristics of the DAC (e.g., a DAC of a control ASIC chip, such as a MCU chip), and a maximum current I_{M,S} required for the PIN-based VOA to achieve maximum attenuation. That is, in some implementations, the leakage current Iₗₑₐₖ of the driving electronics 202 may be based on an output voltage offset δV_{DAC} of the DAC of the MCU chip, the full-scale output voltage VES of the DAC, and the maximum source current I_{M,S} to maximize attenuation. In one example, given that output characteristics may be similar across different DACs (e.g., given similar MCU designs), and that a maximum attenuation specification may be defined (e.g., by an industry standard), 0.25 mA is a typical value of leakage current Iₗₑₐₖ for the driving electronics 202 for PIN-based VOA described in FIG. 2A-2E. As indicated above, FIG. 5 is provided as an example. Other examples may differ from what is described with regard to FIG. 5.

Furthermore, there exists a lower limit for the resistance of the shunt resistor 212 (Rₛₕ). In some implementations, the lower limit for the resistance Rₛₕ may be determined based on a maximum current rating (I_{MAX,sh}) and a maximum voltage rating (V_{MAX,sh}) of the shunt resistor 212. In some implementations, the maximum current rating/MAX,sh and maximum voltage rating V_{MAX,sh} may be limited by a wafer fabrication process. Further, as a bypass component, the shunt resistor 212 should not reach its maximum voltage rating V_{MAX,sh} before the PIN-based VOA reaches its maximum voltage rating V_{MAX,D}, i.e., V_{MAX,sh}≥V_{MAX,D}. Thus, in some implementations, the lower limit for the resistance Rₛₕ can be determined using:

$${R}_{s h} \geq \frac{{V}_{MAX , D}}{{I}_{MAX , sh}} \qquad ( 10 )$$

That is, in some implementations, the resistance value Rₛₕ of the shunt resistor 212 may be based on the maximum current rating/MAX,sh of the shunt resistor 212 and the maximum voltage rating V_{MAX,D} of the PIN-based VOA. More particularly, in some implementations, the resistance value Rₛₕ of the shunt resistor 212 may be greater than or equal to the maximum voltage rating V_{MAX,D} divided by the maximum current rating I_{MAX,sh}. Taking the VOA circuitry 200 of FIGS. 2A-2E as an example, a maximum voltage rating V_{MAX,D} of the PIN-based VOA of the PIC 201 is 7.0 V, and the maximum current rating I_{MAX,sh} of the shunt resistor 212 is 50 mA. In this example, the lower limit for the resistance Rₛₕ is 0.14 kΩ (e.g., Rₛₕ≥7.0 V/50 mA=0.14 kΩ).

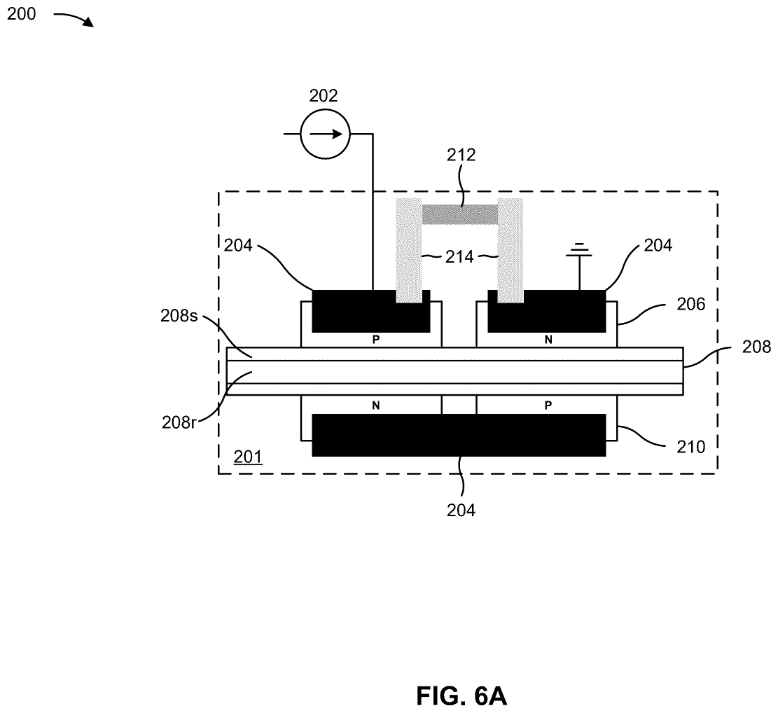

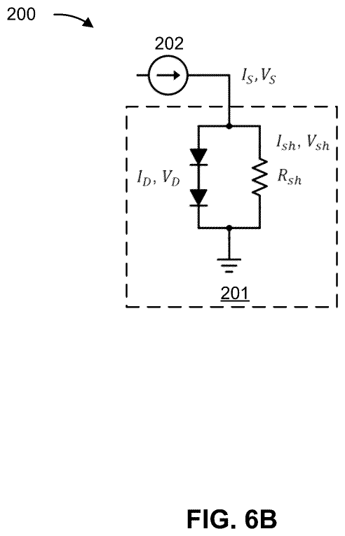

FIGS. 6A-6B are diagrams associated with an additional example for VOA circuitry 200 comprising a PIC 201 including a PIN-based VOA and a shunt resistor 212 as described herein. FIG. 6A is an example top view of the additional example of the VOA circuitry 200, and FIG. 6B is a diagram illustrating an electrical schematic of the VOA circuitry 200 shown in FIG. 6A.

In the example shown in FIGS. 6A-6B, the PIN-based VOA of the PIC 201 comprises two PIN junctions that are connected in series and arranged in an alternating configuration. In this example, the turn-on threshold voltage Vₜₕ of the PIN-based VOA is two times that of a single PIN junction (e.g., 2×0.7 V=1.4 V). Further, the leakage current Iₗₑₐₖ of the driving electronics 202 is 0.15 mA, which may be calculated based on output voltage characteristics of a DAC (e.g., δV_{DAC} and V_{FS}) and a maximum current I_{M,S} required for the PIN-based VOA to achieve maximum attenuation as described above. Thus, the upper limit of the resistance of the shunt resistor 212 (Rₛₕ) in this example is 9.33 kΩ (e.g., Rₛₕ≤Vₜₕ/Iₗₑₐₖ=1.4 V/0.15 mA=9.33 kΩ). In one example, a maximum voltage rating V_{MAX,D} of the PIN-based VOA is 5.0 V, and a maximum current rating/MAX,sh of the shunt resistor 212 is 50 mA. Thus, the lower limit for the resistance of the shunt resistor 212 in this example is 0.10 kΩ (e.g., Rₛₕ≥V_{MAX,D}/I_{MAX,sh}=5.0 V/50 mA=0.10 kΩ).

As indicated above, FIGS. 6A-6B are provided as examples. Other examples may differ from what is described regarding FIGS. 6A-6B. The number and arrangement of elements shown in FIGS. 6A-6B are provided as an example. In practice, there may be additional elements, fewer elements, different elements, or differently arranged elements than those shown in FIGS. 6A-6B. Furthermore, two or more elements shown in FIGS. 6A-6B may be implemented within a single element, or a single element shown in FIGS. 6A-6B may be implemented as multiple, distributed elements. Additionally, or alternatively, a set of elements (e.g., one or more elements) shown in FIGS. 6A-6B may perform one or more functions described as being performed by another set of elements shown in FIGS. 6A-6B.

In some implementations, the VOA circuitry 200 including the PIC 201 with the PIN-based VOA and the shunt resistor 212 does not increase the size of the PIN-based VOA or the size of the PIC 201 (e.g., as compared to a conventional PIN-based VOA without the shunt resistor 212). Further, by bypassing leakage current, the shunt resistor 212 enables the PIN-based VOA in the PIC 201 to operate as a truly bright semiconductor VOA. Additionally, the on-chip solution provided by the VOA circuitry 200 aligns with a trend of vertical integration in the optical communication industry and represents an improved solution of the leakage current issue. Notably, the techniques and apparatuses described herein can be applied to PIN-based VOAs other than those based in silicon, such as a PIN-based VOA implemented in indium phosphide (InP).

In some implementations, the VOA circuitry 200 described above can be included in a coherent optical transceiver. For example, a coherent optical transceiver may include a PIC 201 comprising a TX including a TX VOA (e.g., a first PIN-based VOA associated with attenuating outgoing optical signals) and a TX shunt resistor 212, with the TX shunt resistor 212 being connected in parallel with the TX VOA. In this example, the PIC 201 may further include an RX including an RX VOA (e.g., a second PIN-based VOA associated with attenuating incoming optical signals) and an RX shunt resistor 212, with the RX shunt resistor 212 being connected in parallel with the RX VOA. In some implementations, the coherent optical transceiver may include one or more additional TX VOAs and/or one or more additional RX VOAs, each connected in parallel with a respective shunt resistor 212. The VOA circuitry 200 may further include driving electronics 202 (e.g., a VCCS) associated with driving the TX VOA and the RX VOA.

More generally, the VOA circuitry 200 described above can be included in an optical device comprising driving electronics 202 (e.g., a VCCS) and a PIC 201 that comprises a PIN-based VOA and an on-PIC shunt resistor 212, with the on-PIC shunt resistor 212 being connected in parallel with the PIN-based VOA so that the on-PIC shunt resistor 212 can bypass a leakage current of the driving electronics 202 as described above. The optical device may be, for example, a coherent transceiver, an IM-DD transceiver, a VMUX, or a ROADM. In some implementations, the PIC 201 may include a TX and/or an RX, or may include a VMUX.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a metal layer, one or more metal layers, a group of metal layers, or the like) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A variable optical attenuator (VOA) circuitry comprising:
a photonic integrated circuit (PIC) comprising:
a VOA, wherein the VOA is a positive-intrinsic-negative (PIN)-based VOA,
a shunt resistor, and
one or more metal layers that connect the shunt resistor in parallel with the VOA; and
driving electronics associated with driving the VOA.

2. The VOA circuitry of claim 1, wherein the shunt resistor bypasses a leakage current of the driving electronics.

3. The VOA circuitry of claim 1, wherein the VOA comprises multiple PIN junctions connected in series.

4. The VOA circuitry of claim 1, wherein the shunt resistor comprises a metal or a metal alloy.

5. The VOA circuitry of claim 1, wherein the shunt resistor comprises doped silicon.

6. The VOA circuitry of claim 1, wherein the PIC comprises a set of metal layers connected to the VOA through one or more vias.

7. The VOA circuitry of claim 1, wherein the PIC comprises a set of metal layers connected to the shunt resistor through one or more vias.

8. The VOA circuitry of claim 1, wherein the PIC comprises a set of metal layers that provide routing and connect the VOA in parallel with the shunt resistor through one or more vias.

9. The VOA circuitry of claim 1, wherein the driving electronics include a voltage-controlled-current-source (VCCS) circuit.

10. The VOA circuitry of claim 1, wherein a resistance value of the shunt resistor is based on a turn-on threshold voltage of the VOA and a leakage current of a voltage-controlled-current-source (VCCS) circuit included in the VOA circuitry.

11. The VOA circuitry of claim 10, wherein the resistance value is less than or equal to the turn-on threshold voltage of the VOA divided by the leakage current of the VCCS.

12. The VOA circuitry of claim 10, wherein the leakage current of the VCCS is based on one or more output characteristics of a digital-to-analog-convertor (DAC) of a control chip.

13. The VOA circuitry of claim 10, wherein the leakage current of the VCCS is based on an output voltage offset of a digital-to-analog convertor (DAC) of a control chip, a full-scale output voltage of the DAC of the control chip, and a maximum source current from the VCCS needed to maximize attenuation of the VOA.

14. The VOA circuitry of claim 1, wherein a resistance value of the shunt resistor is based on a maximum current rating of the shunt resistor and a maximum voltage rating of the VOA.

15. The VOA circuitry of claim 14, wherein the resistance value of the shunt resistor is greater than or equal to a maximum voltage rating of the VOA divided by a maximum current rating of the shunt resistor.

16. The VOA circuitry of claim 1, wherein a first terminal of the shunt resistor is connected to an anode of the VOA and a second terminal of the shunt resistor is connected to a cathode of VOA through on-PIC metal routing.

17. A coherent optical transceiver, comprising:
a photonic integrated circuit (PIC) comprising:
a transmitter (TX) including a TX variable optical attenuator (VOA) and a TX shunt resistor, the TX shunt resistor being connected in parallel with the TX VOA,
wherein the TX VOA is a positive-intrinsic-negative (PIN)-based VOA, and
a receiver (RX) including an RX VOA and an RX shunt resistor, the RX shunt resistor being connected in parallel with the RX VOA,
wherein the RX VOA is a PIN-based VOA; and
driving electronics associated with driving the TX VOA and the RX VOA.

18. An optical device, comprising:
a photonic integrated circuit (PIC) including:
a PIN-based variable optical attenuator (VOA), and
an on-PIC shunt resistor associated with bypassing a leakage current of driving electronics associated with driving the PIN-based VOA,
wherein the on-PIC shunt resistor is connected in parallel with the PIN-based VOA; and
the driving electronics associated with driving the PIN-based VOA.

19. The optical device of claim 18, wherein the optical device is a coherent transceiver, an intensity-modulation direct-detection (IM-DD) transceiver, a variable optical attenuator multiplexer (VMUX), or a reconfigurable optical add-drop multiplexer (ROADM).

20. The optical device of claim 18, wherein the PIC includes at least one of a transmitter or a receiver, or a variable optical attenuator multiplexer (VMUX).
